(19) United States
(12) Patent Application Publication
(10) Pub. No.: US 2024/0264664 A1
(43) Pub. Date: Aug. 8, 2024

(54) SELECTIVE PHASING TO OPTIMIZE ENGAGEMENT IN VIRTUAL ENVIRONMENTS

(71) Applicant: International Business Machines Corporation, Armonk, NY (US)

(72) Inventors: Thomas Jefferson SANDRIDGE, Tampa, FL (US); Jacob Thomas COVELL, New York, NY (US); Simranjit KANDOLA, Hicksville, NY (US); Pranay SAKHRANI, Clarksville, TN (US); Shreya AYYAGARI, New York, NY (US)

(21) Appl. No.: 18/163,386

(22) Filed: Feb. 2, 2023

(51) Int. Cl. G06F 3/01

(52) U.S. Cl. CPC G06F 3/013; A63F 13/48; A63F 13/795

(57) ABSTRACT

Techniques for selective phasing using machine learning are provided. A phasing event for a user in an interactive virtual environment is identified, and a plurality of instances to which the user can be phased is identified. For each respective instance of the plurality of instances, a respective phasing score is generated by processing a first user profile of the first user using a trained machine learning model, where each respective phasing score indicates a respective predicted engagement of the first user with respect to one or more respective entities that are present within the respective instance. An instance, of the plurality of instances, is selected based on the respective phasing score, and the user is phased into the instance.

### BACKGROUND

The present disclosure relates to virtual environment phasing, and more specifically, to dynamically phasing users in virtual environments to optimize engagement.

Virtual environments where users can meet and interact have become increasingly widespread in recent years. Though the depth and complexity of such virtual environments may differ (e.g., from text-based forums to fully immersive virtual reality settings), each generally serves as a platform to enable users with varying backgrounds, preferences, and personalities to intermingle and interact. For example, virtual reality environments can allow users from different regions and cultures to interact via sensory sensations such as sight, touch, sound, and the like.

In some systems, users are delineated into multiple servers or instances of the same virtual environment (e.g., for load balancing). For example, many massive multiplayer online roleplaying games (MMORPGs) split users among a set of instances (also referred to in some cases as worlds or servers), where each such instance generally corresponds to the same environment or area, but with a different set of users included.

### SUMMARY

According to one embodiment of the present disclosure, a method is provided. The method includes identifying a first phasing event for a first user in an interactive virtual environment; identifying a plurality of instances to which the first user can be phased in the interactive virtual environment; generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance; selecting a first instance, of the plurality of instances, based on the respective phasing score; and phasing the first user into the first instance.

According to one embodiment of the present disclosure, a system is provided. The system includes one or more computer processors, and a memory containing a program which when executed by the one or more computer processors performs an operation. The operation includes identifying a first phasing event for a first user in an interactive virtual environment; identifying a plurality of instances to which the first user can be phased in the interactive virtual environment; generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance; selecting a first instance, of the plurality of instances, based on the respective phasing score; and phasing the first user into the first instance.

According to one embodiment of the present disclosure, a computer program product is provided. The computer program product includes a computer-readable storage medium having computer-readable program code embodied therewith, the computer-readable program code executable by one or more computer processors to perform an operation. The operation includes identifying a first phasing event for a first user in an interactive virtual environment; identifying a plurality of instances to which the first user can be phased in the interactive virtual environment; generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance; selecting a first instance, of the plurality of instances, based on the respective phasing score; and phasing the first user into the first instance.

### BRIEF DESCRIPTION OF THE DRAWINGS

FIG. 1 depicts an example computing environment for the execution of at least some of the computer code involved in performing the inventive methods.

FIG. 2 depicts an example workflow for providing dynamic phasing in virtual environments, according to one embodiment disclosed herein.

FIG. 3 is a flow diagram depicting an example method for generating and refining user profiles to provide dynamic phasing in virtual environments, according to one embodiment disclosed herein.

FIG. 4 is a flow diagram depicting an example method for providing dynamic phasing in virtual environments based on user profiles, according to one embodiment disclosed herein.

FIG. 5 is a flow diagram depicting an example method for phasing a user in a virtual environment based on a profile of the user, according to one embodiment disclosed herein.

FIG. 6 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DETAILED DESCRIPTION

Embodiments of the present disclosure provide techniques for dynamic and selective phasing of users based on a variety of metrics and data in order to maximize user engagement.

As used herein, “phasing” in a virtual environment refers to loading users into different “instances” of the environment. In each “instance,” groups of users are able to interact with each other as well as with the environment around them, and the interactions among those users and their environment is generally visible to the other users within the same instance. In an embodiment, multiple “instances” may exist at the same time for the same area, such as to reduce stress on the servers (e.g., to load balance across computational resources) as well as enhance performance for the end users within the interactive virtual environment and/or to prevent overwhelming users with an excessive number of other users at the same time.

In some embodiments of the present disclosure, by utilizing a variety of metrics such as each user's current behavior, past behavioral patterns, and engagement metrics, the disclosed systems are able to provide dynamic and/or selective phasing, where users can be “phased” into new instances with varied groups of other users where they will be more inclined to interact the surrounding users (in the same instance) in a way that increases the probability of beneficial engagement within the instance. Generally, such dynamic phasing can be applied to a wide range of concepts and events, such as users joining a concert they may have otherwise refrained from joining, but decide to do so after seeing the other users (in the same instance) express interest (e.g., where psychological cues can pique interest in otherwise uninterested users, thereby increasing engagement and/or revenue lost). Generally, aspects of the present disclosure are readily applicable to a wide variety of concepts, such as with respect to apparel, conventions, educational engagement, client engagement, virtual theme parks, implementing virtual ideas into real life, and the like.

In some embodiments, the system enables user engagement to be quantified (e.g., based on a user profile) and optimized, potentially in conjunction with other key performance indicators (KPIs) or metrics, such as load balancing. That is, the phasing can be performed in such a way as to optimize multiple metrics (such as server usage and engagement). In some embodiments, the phasing is performed using a learning-based system which leverages one or more machine learning models (e.g., neural networks) and enhanced analytics to selectively group and phase users into specific virtual environment instances to optimize positive engagement and/or other metrics within the virtual environment, based on the selected optimization metric(s).

As one example of dynamic phasing that can be enabled using embodiments of the present disclosure, consider a concert or convention event in a virtual environment. In such an example, suppose a given user is located (in the virtual environment) in an area which has many posters for an upcoming concert or other event, but the user is not initially interested in attending. Suppose further that, in the same area as the first user, a second user who is excited about this concert or event is present, and this second user begins to interact with other nearby users about how exciting the event will be. Naturally, this interaction may create a group of users that are also excited about the upcoming event. Now, if the first user is phased into the same instance and sees the group of users, where more and more other users are joining the conversation and making their way to the event, the first user may be significantly more interested in the event. In this way, selective phasing can cause the first user, who is initially not interested in the event, to become interested due to the dynamic groupings and interactions in the instance.

As another example, consider a theme park or other object in the virtual environment. Suppose a first user is located at or near a theme park in the virtual environment, where a virtual ride (e.g., a rollercoaster) is nearby. If the first user is phased into an instance where no other users are near the rollercoaster, the first user may be unlikely to further interact with the ride and/or other users. In some embodiments, the system may dynamically phase the first user automatically into an instance where a crowd of other users are nearby the ride. As the first user observes and/or interacts with users or other entities in this new instance, they may notice the other users around the ride, which may pique their interest. For example, as discussed above, the first user may see other users talking about the experience and planning to go on the ride, see others waiting in line and talking amongst their friends, and the like. After observing this interest surrounding the ride, the first user may thereafter decide to buy a ticket and experience the ride. In this way, selective phasing may be used to introduce the first user to an audience which is interested in the ride.

As yet another example, consider an office environment where a first user working on a first project is phased into an instance where like-minded individuals or teams are present, helping to create impactful teams and increase talent on the projects. For example, suppose a first user is working as a consultant, and the current project requires him to conduct technological data analysis. Suppose further that the first user is conducting the relevant research while logged into the virtual environment. In an embodiment, the selective phasing system may recognize what project the first user is working on, and phase him to an instance or virtual area with other data analysts, computer scientists, and/or technology experts within the company. Even if each of the users works on their individual projects, the first user is thereby able to ask his fellow colleagues (in this virtual phased space) about various concepts, and other users in the instance may be able to help to fill in knowledge gaps which would have otherwise taken the first user substantial time to research on their own. In this case, the user is thereby able to collaborate and use internal knowledge and talent to become more time efficient and knowledgeable because of the selective phasing system.

As additional non-limiting examples, the selective and dynamic phasing embodiments described herein can help students phase into similar areas of interest to make education much more engaging, phase competitive buyers into areas or instances to showcase home demands to interested buyers (where higher demand in a phased instance may signal buyers to act fast and/or offer a higher price to get a popular property), virtual stores which showcase upcoming merchandise may utilize selective phasing to create attention and attraction towards new items before they are released (virtually or in real shops across the world), companies which showcase virtual events, merchandise, or products and plan to launch similar real-world releases can use data from these selective phasing events to judge the popularity and overall demand for their products, selective rendering/phasing may be used to advertise the product(s) and increase engagement which may initially have been lower, and the like.

Generally, using selective and dynamic phasing based on user profiles, embodiments of the present disclosure are able to provide improved computational load balancing, improved user engagement, and overall improved operations of the virtual environment. That is, embodiments of the present disclosure provide unique and technical solutions to the inherently technical problems that are currently present in such virtual environments in order to improve interactivity and operations of the systems.

Computing environment 100 contains an example of an environment for the execution of at least some of the computer code involved in performing the inventive methods, such as phasing code 200. In addition to phasing code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and phasing code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

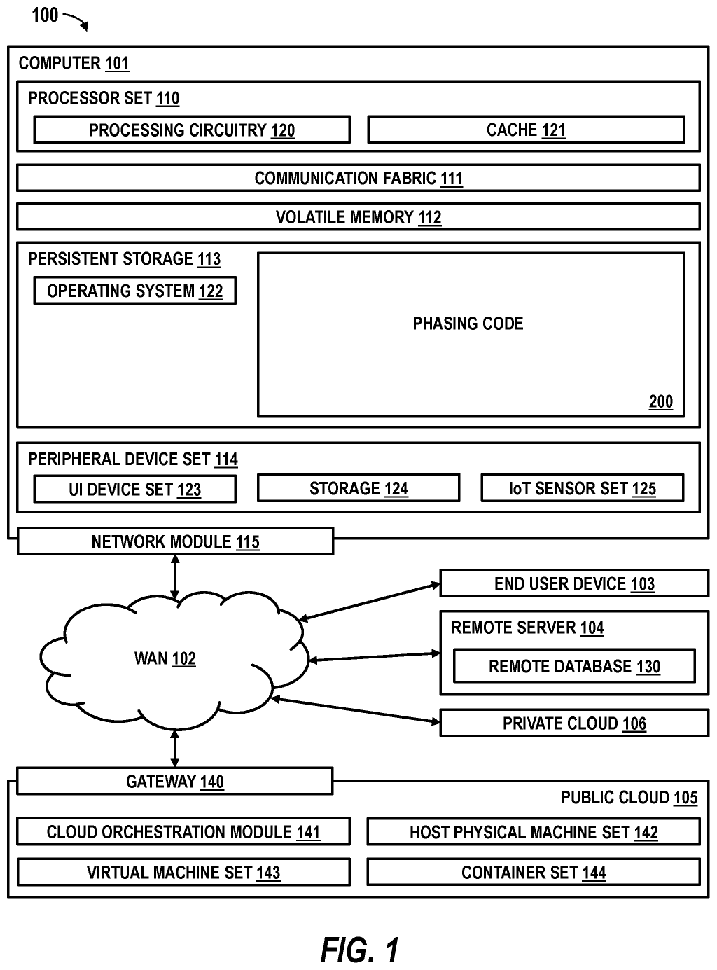

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in phasing code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in phasing code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

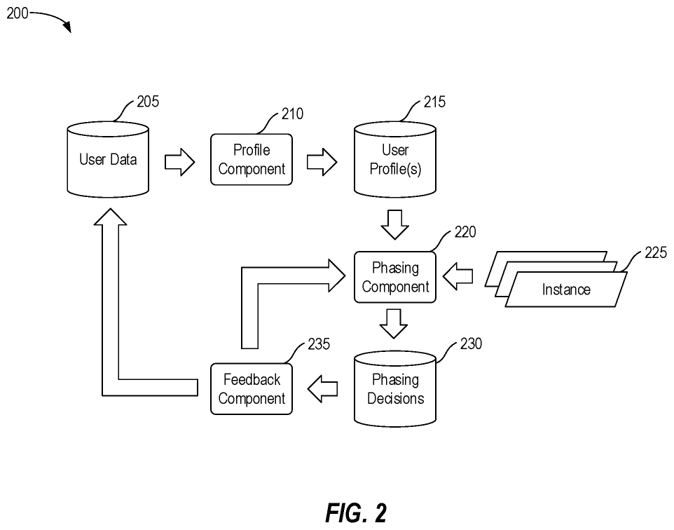

FIG. 2 depicts an example workflow 202 for providing dynamic phasing in interactive virtual environments, according to one embodiment disclosed herein. In the illustrated example, a profile component 210 evaluates user data 205 to generate user profiles 215, which are used by a phasing component 220 to generate phasing decisions 230 for a set of instances 225. Additionally, as illustrated, the phasing decisions can be monitored or evaluated by a feedback component 235 to update the user data 205 and/or user profiles 215.

Although a discrete profile component 210, phasing component 220, and feedback component 235 are depicted for conceptual clarity, in embodiments, the operations of the depicted components (and others not depicted) may be combined or distributed across any number of components. The profile component 210, phasing component 220, and feedback component 235 may each generally be implemented using hardware, software, or a combination of hardware and software. Generally, the depicted components may be used as part of a phasing system to provide dynamic and selective phasing for one or more virtual environments.

Generally, the user data 205 may include a wide variety of data related to one or more users of the virtual environment, including biographical information, historic and/or current interaction information, and the like. Though depicted as a single repository for conceptual clarity, in embodiments, the user data 205 may be distributed across any number and variety of data repositories and sources. In some embodiments, the user data 205 can generally include any data that may be related to or may affect user engagement.

As non-limiting examples, the user data 205 may include information for one or more users such as their native or preferred language, geographic region where they are located, their social/influencer/popularity ranking (e.g., indicating whether they have the ability to influence others), their interests, common topics they discuss or engage with, the vernacular they use, and the like.

In some embodiments, the user data 205 can further include engagement or interaction information or metrics for each user, such as (without limitation) information related to communications between or among users (which may or may not include the specific content or topics of conversation), the size of groups each user tends to engage with, the time each user has spent in the virtual environment (e.g., the number of hours), the time(s) of day when each user engages (e.g., when are they most “social” or active), indications, for each user, of attributes of similar cohorts and/or dissimilar cohorts of users, type(s) of communications the user engages in (e.g., whether they generally engage in positive or negative communications), location(s) or areas in the virtual environment where the user frequents, the type(s) of virtual location(s) where each user is most likely to engage, and the like.

In some embodiments, the user data 205 can additionally or alternatively include information relating to real-time engagement or metrics in the virtual environment. For example, the user data 205 may be generated or augmented using audio and/or text-based natural language processing (NLP) to include, without limitation, information related to whether the user is engaging in positive or negative interactions, information related to the user's behavior within the virtual environment (e.g., social behavior or action behavior, classifications of the current virtual location type (e.g., city, water, and the like), the current context of the user's virtual session (e.g., workspace, game, and the like), what environment or location type(s) where the user tends to engage with advertisements or other aspects of the environment, and the like). In some embodiments, the user data 205 can similarly include information such as inferred or specified relationships among users (e.g., work relationship or gaming relationship), and the like. In some embodiments, the user data 205 may include indicators of the user's current engagement, such as based on the volume of their spoken words, the time spent conversing with others, their proximity to other users within the virtual environment, the amount of virtual “eye contact” (e.g., time spent looking in the direction of other users within environment), the user's tone, biometric indicators such as heart rate, and the like.

As illustrated, the profile component 210 evaluates the user data 205 to generate user profiles 215. In some aspects, the user profiles 215 may be alternatively referred to as models, engagement models, user models, and the like. In some embodiments, as discussed in more detail below, the user profiles 215 are generated using machine learning. Generally, the user profiles 215 may be used to describe predicted or probably engagement metrics for each user (e.g., indicating the concepts that the user is most likely to engage with). In some embodiments, the user profiles 215 are generated by leveraging various correlation and/or classification techniques (e.g., using machine learning) to identify engagement trends and preferences for each user.

For example, in some embodiments, the profile component 210 can leverage one or more clustering techniques, such as k-means, to generate the user profiles 215 based on the user data 205. In some embodiments, the profile component 210 uses a bag-of-words technique (which can provide a feature representation of free-form/natural language text), to extract key words and phrases that are most associated with engagement, as well as how the words and phrases are related to each other, using a co-occurrence model.

In some aspects, the profile component 210 can determine one or more thresholds for how often each user engages with certain things and/or contexts when the user is likely to engage, such as by comparing distributions of certain related items. For example, if a user interacts with amusement park interactions when other similarly aged users are also interacting in the area, then the profile component 210 may generate a user profile 215 reflecting this preference such that the system can phase the specific user into a instances with enough similarly aged users already interacting in the area.

In some embodiments, content in the user data 205/user profiles 215 is ranked using a hierarchy that utilizes time decay, where the most recent activities and other users that each given user engages with are assumed to be the strongest driving factors. For example, the profile component 210 may determine/generate a user profile 215 reflecting that a first user may be most likely to engage within a metro environment, with a medium size group, and within a similar cohort of users. As another example, the profile component 210 may generate a user profile 215 indicating that a second user may tend to engage only in one-on-one conversations with other users whom they have historic work relationships with when in a workspace environment, but that they tend to branch out and meet new users when they are in a gaming environment.

In the illustrated example, the user profiles 215 can then be used by a phasing component 220 to generate phasing decisions 230 for a set of instances 225. As discussed above, each instance 225 may generally correspond to a copy of a location or area in a virtual environment, such that users within the same instance can interact with each other and the environment, but users in different instances do not see or interact with each other. As the instances 225 are discrete from each other (e.g., interactions in one do not overlap or affect another), they can be hosted or provided using separate computational hardware, enabling load balancing.

In some embodiments, the phasing component 220 can monitor the environment and/or users to determine when phasing is needed for any given user. Phasing events generally correspond to any time when a user needs to be placed into an instance 225. For example, a phasing event may correspond to a loading event when the first user transitions or moves from a first location in the virtual environment to a second location (e.g., entering or exiting a building). As another example, a phasing event may correspond to an onboarding event when the user first enters the environment (e.g., when they log in). As another example, a phasing event may correspond to a determination that the user should otherwise be re-phased, even if no loading event is occurring, such as to mitigate or prevent negative interactions or engagement (e.g., to phase them out of an instance where conflict is imminent, and into a new instance where they can engage more positively).

In some aspects, as discussed above and in more detail below, the phasing component 220 may use machine learning to generate the phasing decisions 230 (e.g., to select an instance 225 for each user at each phasing event). In some embodiments, the phasing component 220 may be configured (manually or programmatically) to target one or more specific optimization metrics for the phasing, such as social engagement, advertisement engagement, load balancing, and the like. When a user initiates a session within the virtual environment or otherwise encounters a phasing event, the phasing component 220 may place them in a phasing queue and utilize machine learning (e.g., a neural-network based virtual Instance optimization module) to selectively group and phase users into specific virtual environment instances, based on the one or more optimization metrics and/or load-balancing metrics.

In some embodiments, the phasing component 220 groups multiple users together to be phased into a single instance 225. In some embodiments, the phasing component 220 can select an instance 225 for each given user based on the other users/entities already present in each instance 225. For example, at a phasing event for a first user, the phasing component 220 may access or retrieve the user profile 215 of the first user, and identify entities in the virtual environment (which may include entities that are present in multiple instances 225, such as scenery, parks, rides, and the like, as well as entities present only in a single instance 225, such as other users, pets of users, and the like). The phasing component 220 may then access the user profiles of each other user in the same location of each specific instance 225, and generate an engagement score indicating the predicted engagement of the first user based on the user profiles.

In the illustrated workflow 202, the feedback component 235 can monitor the phasing decisions 230 (e.g., monitor interactions and engagement in each instance 225) to improve future phasing (e.g., by updating the user data 205 and/or user profiles 215), and/or to update or improve the current phasing (e.g., by providing feedback to the phasing component 220).

For example, in some embodiments, the feedback component 235 may analyze users within each virtual environment instance 225 to assess the results of the selected grouping/phasing in order to rank/score the users' engagement with respect to the selected optimization metric(s) and/or to compare user engagement scores against one or more thresholds. This can enable the feedback component 235 to determine whether the selected instance 225 or grouping of users was successful with respect to the target metric(s).

In some embodiments, the feedback component 235 can use a variety of techniques to evaluate the user engagement, such as monitoring eye movement (e.g., tracking where the user(s) look in the environment, how long they look at various entities, and the like), interactions between users, behavioral patterns, use of language while chatting, explicit user feedback on the phasing, and the like. In an embodiment, the viewed and/or engaged content within the environment can be processed to derive an engagement analysis or measure for each user, allowing the most relevant content, experiences, and/or users to be used for further selective phasing.

In some embodiments, the feedback component 235 can monitor user actions or interactions, such as when a given user chats with other users, buys virtual items, moves to specific areas within the environment, or engages with any other content. The data associated with such interactions can then be stored and/or used to subsequently phase users into areas/instances 225 having related content and subject matter which most-overlap with each user's overall behavioral, engagement/or and interest patterns.

For example, the feedback component 235 may process content and communications (e.g., using natural language processing (NLP), natural language classification (NLC), and/or natural language understanding (NLU)) to derive topic keywords and find activities or content with the greatest degree of alignment to the users engagement interests. As an example, the feedback component 235 may analyze other users in the area with respect to the area's content, and extract activity/engagement topics from the provided area.

In some embodiments, based on the feedback, the system may re-phase if specific threshold(s) are met (e.g., poor engagement). In some embodiments, based on the feedback, the system can perform updated phasing based on the number of times/how often a given user engages with an activity positively, and can change the threshold(s) over time based on the various feedback mechanisms, to drive improved phasing. In some embodiments, the system can overwrite or replace presented content and provide user-specific content based on relational association to activities/content that have the highest relationship/strength with optimizing a user's engagement metrics. For example, the system may utilize cosine similarity to determine the mean distance of a given topic or relationship item, relative to the user's engagement interests.

In some embodiments, if the user is re-phased to a new instance 225, the system optionally alert or inform the user that they have been selectively phased. In some embodiments, the system can further provide explanation as to why the phasing occurred. In at least one embodiment, the system can provide an option to accept or reject the new phasing.

In some embodiments, the feedback component 235 and/or phasing component 220 can curate the phasing decisions 230 in order to prevent manipulation of user engagement that might negatively affect user experience. For example, selective phasing may correlate activities and users having similar interests with other controversial topics, resulting in behavioral cues that which may be misinterpreted as improved engagement. In some embodiments, therefore, activities and events within the virtual environment may be ranked based on their risk of manipulation in order to derive more accurate correlations of phasing and calculated risks of manipulation of the engagement optimization. In one such embodiment, both user engagement patterns and content of the selective phasing may be assessed (e.g., utilizing cosine similarity) to derive the mean distance between behavioral patterns, the context of the phasing, and the risks of manipulation.

In an embodiment, if the selected phasing deviates beyond a defined threshold from the desired topic, the system can refrain from phasing users into the new environment to prevent misleading and manipulative user engagement. That is, the system may actively phase users to prevent negative engagement and/or manipulated engagement, which can further be leveraged to prevent echo chambers from forming (as they may have a negative impact on the user experiences).

As discussed above, the feedback mechanisms used to provide improved phasing can vary depending on the particular implementation. In some embodiments, phasing is selectively curated to each user, and the system can enact a learning process using one or more feedback loops to determine if aggregate engagement increases based on the phasing decisions 230. For example, the system may use supervised learning based on positive feedback (e.g., when the observed user engagement improves or is above a threshold) as well as negative feedback (e.g., when the observed user engagement declines or is below a defined threshold). That is, feedback based on whether each user engages with the other users and/or events and interacts within the selected instances 225 can be determined.

In some embodiments, if a given user interacts within the instance 225 that the system phased them into (e.g., due to interest or because of the behavior received from nearby users), then the system can learn to phase the given user into similar contexts that included those interest groups, behavioral attributes, and/or activities. Similarly, if a given user does not interact within the instance 225 that the system phased them into (e.g., due to lack of interest or because of the adverse behavior received from nearby users), then the system can learn to phase the given user into different contexts that do not include those interest groups, behavioral attributes, and/or activities.

As another example, if a user is phased into a specific instance and leaves quickly (e.g., within a defined window), then the system can learn that the selected phasing was not effective. As another example, eye tracking and player viewing times can be further leveraged in order to determine the phasing efficacy and/or changes in the mean time spent in the area. Generally, an increase in time spent within an area (especially if it leads to the user interacting with other players, live events, activities, or purchasing of virtual items) can be correlated with increased effectiveness of the model and used to further refine the model.

In some embodiments, as discussed above, the system may additionally or alternatively collect manual feedback from one or more user(s). For example, the user may manually enter or indicate whether the people and environmental attractions around them in the virtual environment contributed positively or negatively to their experience. In some embodiments, the system can prompt one or more users to provide feedback as to whether they enjoyed their experience within the virtual environment, such as when the user enters or leaves an area. This feedback can take a variety of forms, including a simple binary indication (e.g., thumbs up/down), or additional information (e.g., verbal or textual) which may be analyzed via NLP.

Generally, using the workflow 202, the system can selectively and dynamically phase users among the instances 225 to improve load balancing, engagement, and any other desired metric using machine learning.

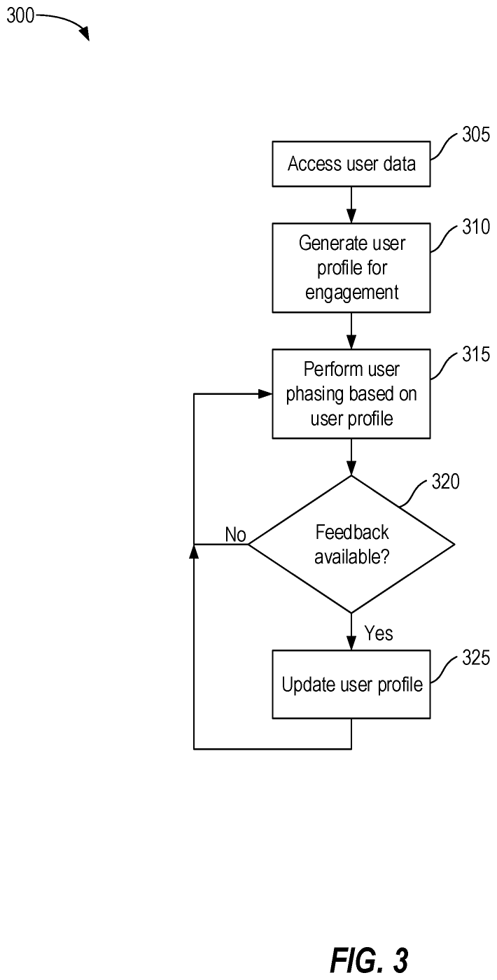

FIG. 3 is a flow diagram depicting an example method 300 for generating and refining user profiles to provide dynamic phasing in virtual environments, according to one embodiment disclosed herein. In some embodiments, the method 300 is performed by a phasing system, such as discussed above with reference to FIGS. 1 and/or 2.

At block 305, the phasing system accesses user data (e.g., user data 205 of FIG. 2). As used herein, accessing data can generally include receiving it, requesting it, retrieving it, or otherwise gaining access to it. In some embodiments, as discussed above, the user data can generally include a variety of information describing the characteristics or attributes of one or more users, historic and/or current behaviors or interactions, and the like. In some embodiments, the phasing system accesses data for a each individual user to generate a corresponding profile for the user.

At block 310, the phasing system generates a user profile for engagement (e.g., user profile 215 of FIG. 2) based on the accessed user data. For example, as discussed above, the phasing system can use various techniques to learn contexts that are predictive of high and/or low engagement of the user. For example, the user profile may indicate the cohorts of other users (e.g., specific attributes of other users) that are likely or predicted to result in higher engagement of the user if they are phased into the same instance, cohorts that are likely or predicted to result in decreased engagement of the user, preferences of the user, and the like.

At block 315, the phasing system performs user phasing based on the generated user profile. For example, as discussed above and in more detail below, the phasing system may generate a respective phasing score for each respective instance based at least in part on the user profile in order to predict engagement of the user if they are phased into the respective instance. For example, as discussed in more detail below, the phasing system may generate the phasing scores based on whether the user is predicted to engage positively with other users in each instance, whether the user is predicted to be more or less likely to participate in, engage with, or interact with an ongoing event or other entity if they are phased into each instance (e.g., based on other users in each), and the like.

At block 320, the phasing system determines whether feedback is available. In some embodiments, as discussed above, the feedback can include manually provided feedback from the user and/or inferred feedback (e.g., based on monitoring user biometrics, eye movements, interactions, and the like). If feedback is available, the method 300 continues to block 325, where the phasing system updates the user profile of the user. For example, as discussed above, the phasing system may update the profile based on whether the current phasing is resulting in increased engagement. The method 300 then returns to block 315 to perform new phasing, as needed. Additionally, if, at block 320, the phasing system determines that no feedback is available, the method 300 returns to block 315 to continue phasing.

In this way, as discussed above, the method 300 enables the phasing system to generate and refine user profiles to provide dynamic and selective phasing within a virtual environment.

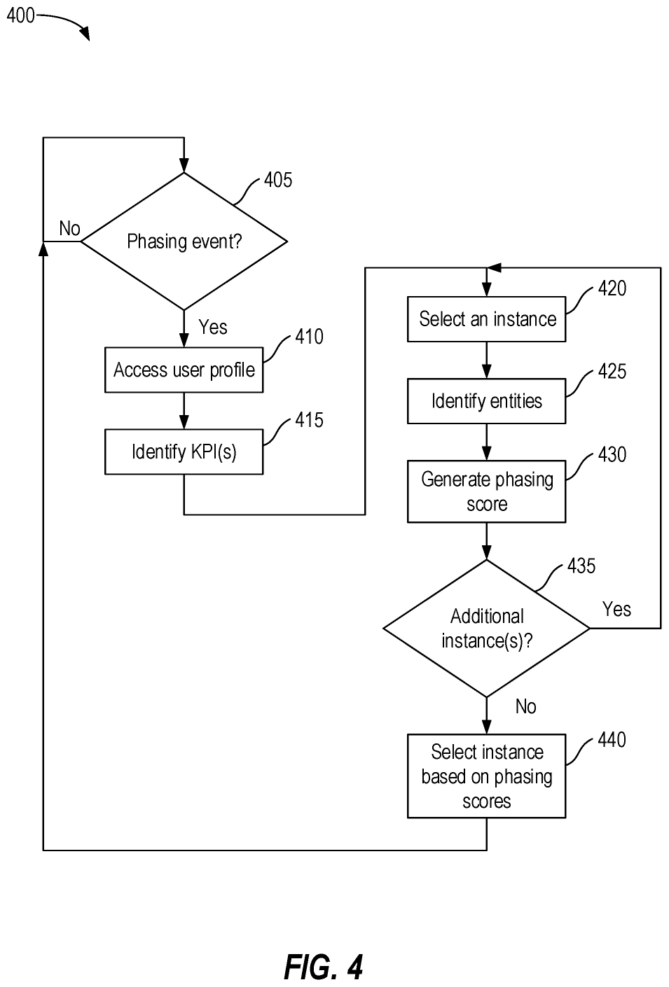

FIG. 4 is a flow diagram depicting an example method for providing dynamic phasing in virtual environments based on user profiles, according to one embodiment disclosed herein. In some embodiments, the method 400 is performed by a phasing system, such as discussed above with reference to FIGS. 1, 2, and/or 3. In at least one embodiment, the method 400 provides additional detail for block 315 of FIG. 3.

At block 405, the phasing system determines whether a given user has reached a phasing event. As discussed above, the phasing events may generally correspond to times when the user should be phased into a new instance, such as when they first log in, when they enter a new area or loading zone, when there are problems such as conflict or low engagement in their current instance, and the like. If the phasing system determines that the user is not at a phasing event, the method 400 loops at block 405 until a phasing event is reached.

If, at block 405, the phasing system determines that the user has reached a phasing event, the method 400 continues to block 410, where the phasing system accesses the user profile of the user. At block 415, the phasing system determines or identifies one or more KPIs that the system seeks to optimize with the phasing. That is, the phasing system can identify the metric(s), which may be specified by an administrator, to optimize (such as engagement in general, social engagement with other users, engagement with advertisements, engagement with specific events or objects in the environment, computational load balancing, latency experienced by the user, and the like).

At block 420, the phasing system selects an instance, from a set of instances to which the user may be phased, for evaluation. Generally, the phasing system can use any suitable technique to select the instance, including randomly or pseudo-randomly, as each instance may be evaluated during the method 400 to select the optimal one.

At block 425, the phasing system identifies a set of entities that are present in the selected instance. In some embodiments, as discussed above, the set of entities correspond to elements that are specific to the selected instance/are not present in other instances. For example, the entities may include other users in the selected instance, events or objects that are only present in the selected instance, and the like. As an example, if the user is entering a park area, the phasing system may determine the context of any events occurring in the park (e.g., where one instance is hosting a dog show, one instance is hosting a birthday party, and the like), the other user(s) present in each, and the like. In some embodiments, the set of entities may be referred to as the “context” of the instance.

At block 430, the phasing system generates a phasing score, with respect to the indicated metric(s) or KPI(s), for the selected instance based on the identified entities and the user profile of the user. For example, as discussed above, the phasing system may use machine learning to process the user profile and/or context of the instance to generate a measure or score indicating the predicted engagement of the user if they are phased into the selected instance. In some aspects, as discussed above, this can include accessing and evaluating the user profiles of each other user in the instance, evaluating the current interactions occurring in the instance, and the like.

In some embodiments, as discussed above, the phasing machine learning model(s) can be trained and/or refined to provide better phasing. For example, training samples may be created for prior phasing decisions, where the input portion of each training sample includes the profile of a given user and the context of a given phasing (e.g., the other users present in the instance, other entities or events, and the like). The label or target output portion of each training sample can include engagement information (e.g., determining using various feedback mechanisms) indicating whether the given phasing decision affected the indicated KPI(s) in the desired way (e.g., whether engagement increased or was above a threshold).

In this way, using supervised learning, the phasing model (e.g., a neural network) can be refined. For example, the phasing model may be used to generate a predicted phasing score based on the input portion of a training sample. This predicted score can then be compared against the label of the sample (e.g., the actual historical engagement), and the weights or other parameters of the model can be refined to minimize the difference between the predicted and actual scores. In this way, the model iteratively learns to generate more accurate phasing scores based on the specific context of a new phasing event/instance. Additionally, as discussed above, the phasing model may be refined based on newly-collected feedback (e.g., periodically) to continue to improve the phasing decisions.

Returning to FIG. 4, once the phasing score is generated for the selected instance, the method 400 continues to block 435, where the phasing system determines whether there is at least one additional instance remaining in the set of instances to which the user may be phased. If so, the method 400 returns to block 420 to select the next instance. If not, the method 400 continues to block 440. Although the illustrated example depicts a sequential process (e.g., where each alternative instance is evaluated iteratively/sequentially) for conceptual clarity, in some aspects, some or all of the instances may be evaluated to generate phasing scores in parallel.

At block 440, the phasing system selects an instance, from the set of instances, based on the generated phasing scores. For example, the phasing system may select the instance having the highest score for the identified KPI(s) (e.g., the highest predicted engagement), or may select the instance that is the best balance of multiple KPIs (e.g., having a high predicted engagement while also satisfying load balancing concerns). The user can then be phased into the instance, as discussed above, and the method 400 returns to block 405 to await the next phasing event.

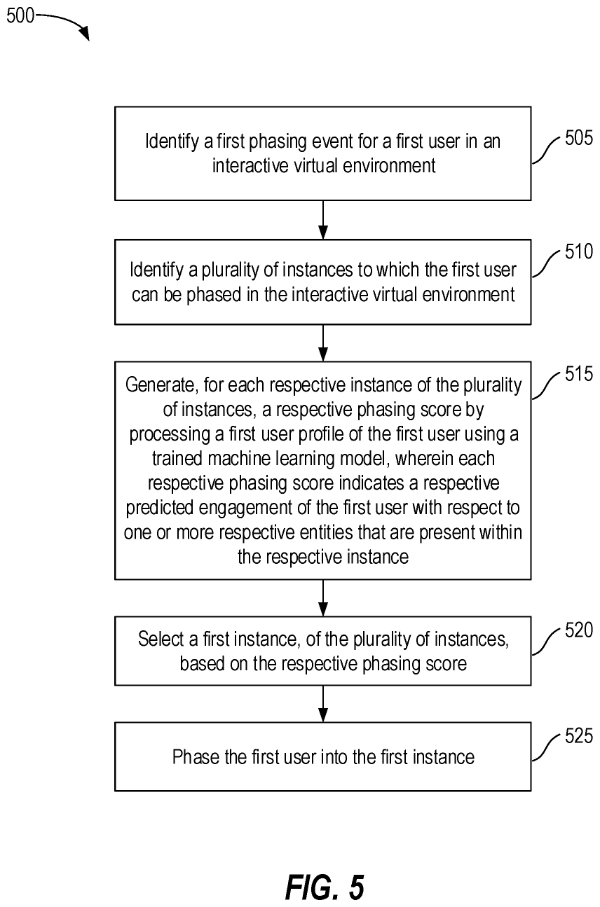

FIG. 5 is a flow diagram depicting an example method 500 for phasing a user in a virtual environment based on a profile of the user, according to one embodiment disclosed herein. In some embodiments, the method 500 is performed by a phasing system, such as discussed above with reference to FIGS. 1-4.

At block 505, a first phasing event for a first user in an interactive virtual environment is identified.

At block 510, a plurality of instances to which the first user can be phased in the interactive virtual environment is identified.

At block 515, a respective phasing score is generated, for each respective instance of the plurality of instances, by processing a first user profile of the first user using a trained machine learning model, wherein each respective phasing score indicates a respective predicted engagement of the first user with respect to one or more respective entities that are present within the respective instance.

At block 520, a first instance, of the plurality of instances, is selected based on the respective phasing score.

At block 525, the first user is phased into the first instance.

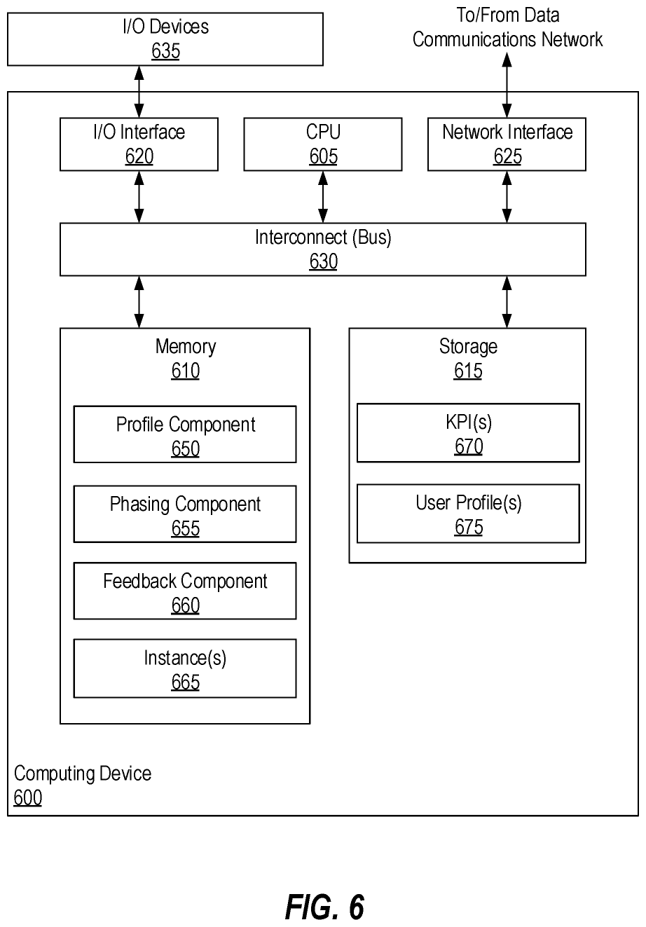

FIG. 6 depicts an example computing device configured to perform various aspects of the present disclosure, according to one embodiment. Although depicted as a physical device, in embodiments, the computing device 600 may be implemented using virtual device(s), and/or across a number of devices (e.g., in a cloud environment). In one embodiment, the computing device 600 corresponds to a phasing system, such as discussed above with reference to FIGS. 1-5.

As illustrated, the computing device 600 includes a CPU 605, memory 610, storage 615, a network interface 625, and one or more I/O interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). For example, the network interface 625 may correspond to a wireless communications radio (e.g., a WiFi radio) that the computing device 600 uses to provide a wireless network (e.g., a WLAN) for client devices. As illustrated, the CPU 605, memory 610, storage 615, network interface(s) 625, and I/O interface(s) 620 are communicatively coupled by one or more buses 630.

In the illustrated embodiment, the memory 610 includes a profile component 650, a phasing component 655, and a feedback component 660, which may perform one or more embodiments discussed above. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

In the illustrated example, the memory 610 also includes a set of instances 665 (which may correspond to instances 225 of FIG. 2). As discussed above, each instance 665 may generally correspond to a copy of a virtual environment that allows users and other entities within the same instance 665 to interact with each other while remaining separate from/unable to interact with entities in other instances. For example, for a city-center location in a virtual environment, each instance 665 may host a corresponding set of users, objects, events, and other entities in the city center. By changing to a different instance 665, a user may be presented with a different set of users, events, and other entities while remaining in the same location (e.g., in the city center).

In some embodiments, the profile component 650 (which may correspond to the profile component 210 of FIG. 2) is used to generate user profiles (e.g., user profiles 675) based on user data. For example, as discussed above, each user profile may correspond to a given user, where the profile may generally reflect or indicate the probable engagement or interactions of the given user in a virtual environment based on various contexts. As one example, the profile may indicate cohort(s) of other users that the given user interacts well with, events that the user likes or dislikes, and the like.

In some embodiments, the phasing component 655 (which may correspond to the phasing component 220 of FIG. 2) is used to phase users between the instances 665 based on user profiles. For example, as discussed above, the phasing component 655 may train and/or use machine learning models to score each instance 665 (e.g., to generate a phasing score indicating predicted engagement or interactivity if the user is phased to the given instance). In some embodiments, as discussed above, the phasing scores are generated based in part on the context of the instance (e.g., other entities in the instance). For example, the model may generate a score based on the profile of the given user, as well as the profile(s) of each other user that is already in the given instance (or is being phased into the instance).

In some embodiments, the feedback component 660 (which may correspond to the feedback component 235 of FIG. 2) is used to collect, monitor, and/or evaluate feedback and other data relating to the quality of phasing decisions. For example, as discussed above, the feedback component 660 may evaluate biometric data such as the user's pulse, blood pressure, movements and activities in the physical world, and the like. Similarly, in some embodiments, the feedback component 660 may evaluate virtual data such as the user's gaze, movements and activities in the virtual world, interactions with other users or entities (e.g., ongoing events in the virtual environment), and the like. Based on such data, the feedback component 660 may determine or quantify user engagement (or any other desired metric), which can be used to update the user profile and/or to refine the phasing model, as discussed above.

In the illustrated example, the storage 615 includes a set of KPIs 670 and user profile(s) 675. In some embodiments, the KPIs 670 correspond to metrics that the computing device 600 seeks to optimize when making phasing decisions. For example, the KPIs 670 may include social engagement metrics, advertisement engagement metrics, load balancing metrics, time played metrics, and the like. In some embodiments, the KPIs 670 may be manually curated or specified (e.g., by an administrator). The user profiles 675 (which may correspond to the user profiles 215 of FIG. 2) generally include or indicate the engagement preferences of the users, as discussed above. Although depicted as residing in storage 615, the KPIs 670 and user profiles 675 may be stored in any suitable location, including memory 610.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

While the foregoing is directed to embodiments of the present invention, other and further embodiments of the invention may be devised without departing from the basic scope thereof, and the scope thereof is determined by the claims that follow.

What is claimed is:

1. A method, comprising:
identifying a first phasing event for a first user in an interactive virtual environment;
identifying a plurality of instances to which the first user can be phased in the interactive virtual environment;
generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance;
selecting a first instance, of the plurality of instances, based on the respective phasing score; and
phasing the first user into the first instance.

2. The method of claim 1, wherein the first phasing event corresponds to at least one of:
a loading event when the first user transitions from a first virtual location to a second virtual location in the interactive virtual environment, or
an onboarding event when the first user enters the interactive virtual environment.

3. The method of claim 1, wherein generating the respective phasing scores comprises, for the first instance:
identifying a plurality of users that are present in the first instance;
accessing a plurality of user profiles for the plurality of users; and
generating an engagement score indicating the predicted engagement based on the plurality of users profiles and the first user profile.

4. The method of claim 1, wherein the respective phasing scores are generated based further on one or more load balancing metrics for the plurality of instances.

5. The method of claim 1, further comprising updating the first user profile based on engagement of the first user with the one or more entities that are present within the first instance.

6. The method of claim 5, further comprising determining the engagement of the first user with the one or more entities, comprising one or more of:
monitoring interactions between the first user and at least one other user of a plurality of users that are present in the first instance,
monitoring eye movement of the first user, or
receiving user feedback relating to the first instance.

7. The method of claim 5, further comprising:
identifying second first phasing event for the first user;
generating, for each respective instance of the plurality of instances, a respective second phasing score based at least in part on the updated first user profile; and
phasing the first user into a second instance based on the generated second phasing scores.

8. The method of claim 1, wherein the first instance is selected based at least in part on determining that the first user is more likely to participate in an ongoing event in the interactive virtual environment if phased into the first instance, as compared to a second instance of the plurality of instances.

9. A system, comprising:
one or more computer processors; and
a memory containing a program which when executed by the one or more computer processors performs an operation, the operation comprising:
identifying a first phasing event for a first user in an interactive virtual environment;
identifying a plurality of instances to which the first user can be phased in the interactive virtual environment;
generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance;
selecting a first instance, of the plurality of instances, based on the respective phasing score and
phasing the first user into the first instance.

10. The system of claim 9, wherein the first phasing event corresponds to at least one of:
a loading event when the first user transitions from a first virtual location to a second virtual location in the interactive virtual environment, or
an onboarding event when the first user enters the interactive virtual environment.

11. The system of claim 9, wherein generating the respective phasing score comprises, for the first instance:
identifying a plurality of users that are present in the first instance;
accessing a plurality of user profiles for the plurality of users; and
generating an engagement score indicating the predicted engagement based on the plurality of users profiles and the first user profile.

12. The system of claim 9, the operation further comprising:
updating the first user profile based on engagement of the first user with the one or more entities that are present within the first instance;
determining the engagement of the first user with the one or more entities, comprising one or more of:
monitoring interactions between the first user and at least one other user of a plurality of users that are present in the first instance,
monitoring eye movement of the first user, or
receiving user feedback relating to the first instance.

13. The system of claim 12, the operation further comprising:
identifying second first phasing event for the first user;
generating, for each respective instance of the plurality of instances, a respective second phasing score based at least in part on the updated first user profile; and
phasing the first user into a second instance based on the generated second phasing scores.

14. The system of claim 9, wherein the first instance is selected based at least in part on determining that the first user is more likely to participate in an ongoing event in the interactive virtual environment if phased into the first instance, as compared to a second instance of the plurality of instances.

15. A computer program product comprising a computer-readable storage medium having computer-readable program code embodied therewith, the computer-readable program code executable by one or more computer processors to perform an operation comprising:
identifying a first phasing event for a first user in an interactive virtual environment;
identifying a plurality of instances to which the first user can be phased in the interactive virtual environment;
generating, for each respective instance of the plurality of instances, a respective phasing score by processing a first user profile of the first user using a trained machine learning model, wherein each respective phasing score indicates a respective predicted engagement of the first user with respect to one or more respective entities that are present within the respective instance;
selecting a first instance, of the plurality of instances, based on the respective phasing score and
phasing the first user into the first instance.

16. The computer program product of claim 15, wherein the first phasing event corresponds to at least one of:
a loading event when the first user transitions from a first virtual location to a second virtual location in the interactive virtual environment, or
an onboarding event when the first user enters the interactive virtual environment.

17. The computer program product of claim 15, wherein generating the respective phasing scores comprises, for the first instance:
identifying a plurality of users that are present in the first instance;
accessing a plurality of user profiles for the plurality of users; and
generating an engagement score indicating the predicted engagement based on the plurality of users profiles and the first user profile.

18. The computer program product of claim 15, the operation further comprising:
updating the first user profile based on engagement of the first user with the one or more entities that are present within the first instance;
determining the engagement of the first user with the one or more entities, comprising one or more of:
monitoring interactions between the first user and at least one other user of a plurality of users that are present in the first instance,
monitoring eye movement of the first user, or
receiving user feedback relating to the first instance.

19. The computer program product of claim 18, the operation further comprising:
identifying second first phasing event for the first user;
generating, for each respective instance of the plurality of instances, a respective second phasing score based at least in part on the updated first user profile; and
phasing the first user into a second instance based on the generated second phasing scores.

20. The computer program product of claim 15, wherein the first instance is selected based at least in part on determining that the first user is more likely to participate in an ongoing event in the interactive virtual environment if phased into the first instance, as compared to a second instance of the plurality of instances.
